(19) United States
(12) Patent Application Publication
(10) Pub. No.: US 2013/0068549 A1
(43) Pub. Date: Mar. 21, 2013

(54) BICYCLE WITH ELECTRICAL DRIVE SYSTEM

(71) Applicant: Paul Laprade, Delson (CA)

(72) Inventor: Paul Laprade, Delson (CA)

(21) Appl. No.: 13/635,450

(22) PCT Filed: Mar. 17, 2011
(86) PCT No.: PCT/CA2011/050146

§ 371 Date: Nov. 28, 2012

Related U.S. Application Data
(60) Provisional application No. 61/314,773, filed on Mar. 17, 2010.

(51) Int. Cl. B62M 6/40

(52) U.S. Cl. CPC B62M 6/40
USPC 180/206.1; 180/65.1

(57) ABSTRACT

An electrically-driven bicycle comprises a bicycle frame. A bottom bracket shell is provided at a junction between a down tube and stays of the frame. An electric motor is connected to the bottom bracket shell, the electric motor having a hollow drive shaft with an output end projecting to a first side of the bottom bracket shell. A transmission connects the drive shaft to one of the a wheel and a drive train of the bicycle, to transmit a drive of the electric motor to the rear wheel. A crank set has an axle rotatably mounted within the hollow drive shaft for rotating independently from the drive shaft. Means are provided for transmitting pedaling actuation on the crank set to the rear wheel, the means being on the second side of the bottom bracket shell. An electrical drive system for bicycle is also provided.

### CROSS-REFERENCE TO RELATED APPLICATION

The present application claims priority on U.S. Provisional Patent Application No. 61/314,773, incorporated herewith by reference.

### FIELD OF THE INVENTION

The present disclosure relates to electrically driven bicycles and, more particularly, to a positioning of the various components of the electrical drive system on a bicycle, and to a configuration of electrical drive system.

### BACKGROUND OF THE INVENTION

It is commonly known to use electrical drive systems with bicycles. In such bicycles, the bicycles are not fully powered with the electrical drive system. Rather, the electrical drive system provides additional power to the pedaling performed by the user of the bicycle. Therefore, in conditions like hill climbing and headwind riding, additional power allows the rider to maintain relatively high speed while reducing the amount of additional pedaling power required.

However, an important aspect of electrical drive system is where the various electrical components are positioned within the frame of the bicycle, as the frame of the bicycle has a relatively standard geometry, and how the electrical power is applied to the wheel.

### SUMMARY OF THE APPLICATION

It is therefore an aim of the present application to provide a novel bicycle frame and electrical drive assembly.

Therefore, in accordance with a first embodiment, there is provided an electrically-driven bicycle comprising: a bicycle frame having a front frame portion to which a front wheel is rotatably mounted, and a rear frame portion to which a rear wheel is rotatably mounted, with a bottom bracket shell at a junction between a down tube of the front frame portion and stays of the rear frame portion; an electric motor connected to the bottom bracket shell, the electric motor having a hollow drive shaft with an output end projecting to a first side of the bottom bracket shell; a transmission connecting the output end of the drive shaft to at least one of the rear wheel and a drive train of the bicycle, to transmit a drive of the electric motor to the rear wheel; and the drive train comprising a crank set having an axle rotatably mounted within the hollow drive shaft for rotating independently from the drive shaft, and means for transmitting pedaling actuation on the crank set to the rear wheel, the means being on the second side of the bottom bracket shell.

Further in accordance with the first embodiment, coils of the electric motor are accommodated in the bottom bracket shell.

Still further in accordance with the first embodiment, the hollow drive shaft is rotatably mounted to the bottom bracket shell by bearings.

Still further in accordance with the first embodiment, the transmission comprises a drive transmitting unit between the output end of the hollow drive shaft and a hub of the rear wheel, to directly transmit the drive of the electric motor to the rear wheel.

Still further in accordance with the first embodiment, the transmission comprises a drive transmitting unit between the output end of the hollow drive shaft and a transfer axle rotatably mounted to the stays, to transmit a drive of the electric motor to the rear wheel through the transfer axle.

Still further in accordance with the first embodiment, the transfer axle has a sprocket operatively engaged with a chain of the drive train.

Still further in accordance with the first embodiment, the crank set has a ratchet system between cranks and a chain ring of the drive train.

Still further in accordance with the first embodiment, the transfer axle is operatively connected to the rear wheel by a second drive transmitting unit, the transfer axle having at least one of gears, pulleys and sprockets at an input end and output end for altering a transmission ratio between the drive transmitting units. Still further in accordance with the first embodiment, the transmission comprises one of pulleys and at least one belt, and of sprockets and at least one chain.

Still further in accordance with the first embodiment, the axle of the crank set is rotatably mounted inside the hollow drive shaft of the electric motor by bearings.

Still further in accordance with the first embodiment, rotational axes of the hollow drive shaft and of the axle are coincident.

In accordance with a second embodiment, there is provided an electrical drive system for bicycle comprising: a stator adapted to be fixedly received in a bottom bracket shell of a bicycle frame; a hollow drive shaft supporting a rotor and adapted to rotate as actuated by the cooperation of the rotor and the stator, the hollow drive shaft sized to have an output end projecting to a side of the bottom bracket shell away from a drive train of the bicycle; axle bearings in an inner cavity of the hollow drive shaft adapted to rollingly support an axle of a crank set such that the axle projects from both ends of the drive shaft; and a transmission adapted to connect the output end of the drive shaft to at least one of the rear wheel and a drive train of the bicycle, to transmit a drive of the electrical drive system to the bicycle.

Further in accordance with the second embodiment, bottom bracket bearings are provided and the hollow drive shaft is adapted to be rotatably supporting to the bottom bracket shell by the bottom bracket bearings. Still further in accordance with the second embodiment, the transmission comprises a drive transmitting unit between the output end of the hollow drive shaft and a hub of the rear wheel, to directly transmit the drive of the electrical drive system to the rear wheel.

Still further in accordance with the second embodiment, the transmission comprises a drive transmitting unit between the output end of the hollow drive shaft and a transfer axle adapted to be rotatably mounted to the stays, to transmit a drive of the electric motor to the rear wheel through the transfer axle.

Still further in accordance with the second embodiment, the transfer axle has a sprocket adapted to be operatively engaged with a chain of the drive train.

Still further in accordance with the second embodiment, the transfer axle is operatively connected to the rear wheel by a second drive transmitting unit, the transfer axle having at least one of gears, pulleys and sprockets at an input end and output end for altering a transmission ratio between the drive transmitting units.

Still further in accordance with the second embodiment, the transmission comprises one of pulleys and at least one belt, and of sprockets and at least one chain.

Still further in accordance with the second embodiment, rotational axes of the hollow drive shaft and of the axle bearings are coincident.

### BRIEF DESCRIPTION OF THE DRAWINGS

FIG. 1 is a left-side elevation view of a bicycle with an electrical drive system in accordance with an embodiment of the present disclosure, with a motor being behind the seat tube;

FIG. 2 is a rear right side perspective view of the bicycle of FIG. 1, with fragmentation to show parts of the electrical drive system;

FIG. 3 is a side elevation view of a bicycle with an electrical drive system in accordance with another embodiment of the present disclosure, with a motor being in a bottom bracket shell;

FIG. 4 is an enlarged perspective view of a bottom bracket of the bicycle of FIG. 3;

FIG. 5 is a partly sectioned perspective view of the bottom bracket enclosing the motor of the bicycle of FIG. 3;

FIG. 6 is a sectional view of the bottom bracket enclosing the electric motor for the bicycle of FIG. 3;

FIG. 7 is a partly sectioned left perspective view of the bottom bracket enclosing a motor of a bicycle, with a transmission relating the motor to the drive train of the bicycle;

FIG. 8 is a right perspective view of the bottom bracket enclosing the motor of the bicycle of FIG. 7;

FIG. 9 is a sectional view of the transmission of FIG. 7; and

FIG. 10 is a perspective view of a bottom bracket enclosing a motor of a bicycle, with a transmission relating the motor to the rear wheel of the bicycle.

### DESCRIPTION OF THE PREFERRED EMBODIMENTS

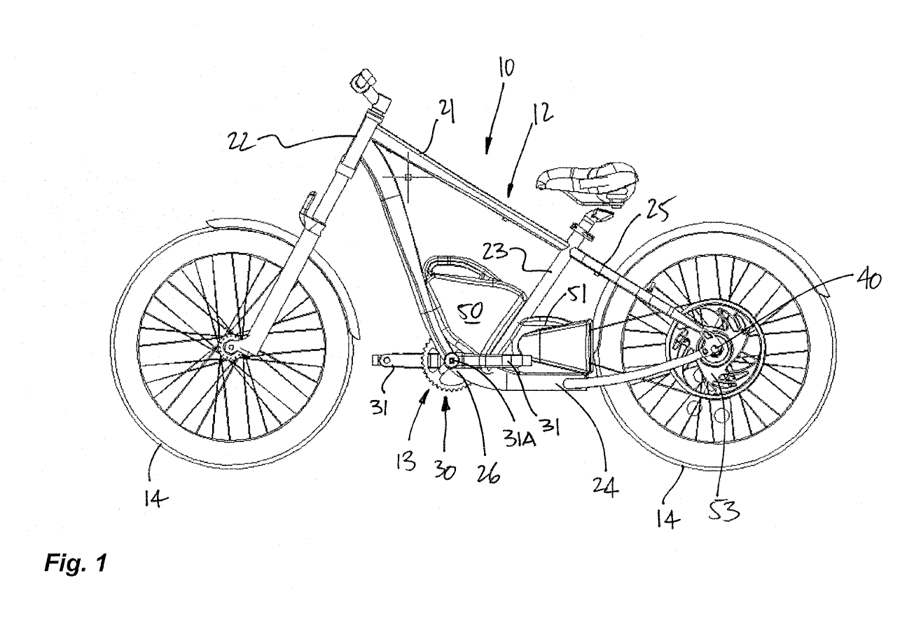

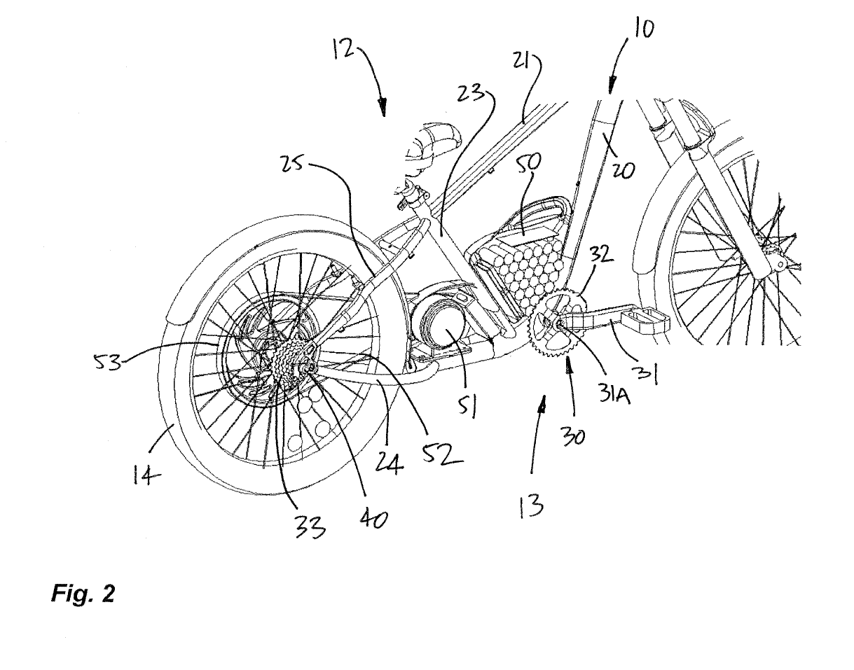

Referring to the drawings, and more specifically to FIGS. 1 and 2, a bicycle having an electrical drive system in accordance with an embodiment of the present disclosure is generally shown at 10. Among many other standard components not described for simplicity purposes, the bicycle 10 has a frame 12, a drive train 13 and wheels 14.

The frame 12 is the main structural component of the bicycle 10.

The drive train 13 transmits pedaling power to the wheels 14.

The wheels 14 are the interface of the bicycle 10 with the road. The frame 12 may be any type of frame. For the present embodiment, a generally standard frame is described, but the electrical drive system may be used with any other type of frame. The frame 12 has a down tube 20 and a top tube 21. The down tube 20 and the top tube 21 are interrelated at a front of the frame 12 by head tube 22. The head tube 22 supports the fork by way of a headset that allows to control the trajectory of bicycle 10 from a handle bar.

The down tube 20 and the top tube 21 diverge from one another toward the rear of the frame 12 and are interconnected by a seat tube 23. A seat post supporting a seat is typically inserted in the seat tube 23 for the telescopic adjustment of the height of the seat. The down tube 20, the top tube 21 and the seat tube 23 concurrently form a front triangle of the frame 12.

A rear wheel 14 is supported by the combination of a chain stays 24 and seat stays 25. The seat tube 23, chain stays 24 and seat stays 25 concurrently form the rear triangle of the frame 12. The chain stays 24 have a support portion adjacent to the seat tube 23. A bottom bracket shell 26 is positioned at the junction between the down tube 20 and the seat tube 23 and supports the crank set 30 (and a spindle thereof). The bottom bracket shell 26 is a tube oriented so as to have an own longitudinal axis normal to a plane of the frame 12.

Referring concurrently to FIGS. 1 and 2, the bottom bracket shell 26 encloses a bottom bracket rotatably supporting a crank set 30 to the frame 12. The crank set 30 has cranks 31 interrelated by an axle/spindle 31A of the bottom bracket, which axle/spindle 31A is journaled by bearings. The cranks 31 support pedals of the bicycle 10. On the right-hand side of the bicycle 10, at least one chain ring 32 is secured to the crank set 30. The chain ring 32 is connected to a cassette 33 of a plurality of cogs (FIG. 2). The chain ring 32 and cassette 33 are interrelated by a chain. Alternatively, a belt-and-pulley drive could be used to transmit pedaling power to the rear wheel 14, or other drives as well such as a shaft drive.

Although not shown, a front derailleur and a rear derailleur may be used to change gear ratios by moving the chain between the chain rings 32 and cogs of the cassette 33. The cassette 33 is typically supported to the rear wheel 14 by way of a free wheel, not visible as it is in the interior of the cassette 33. The free wheel allows the rear wheel 14 to keep on turning while the crank set 30 is idle. The rear wheel 14 rotates about axle 40. The axle 40 supports the cassette 33.

Still referring to FIGS. 1 and 2, the electrical drive system has a battery pack 50 that is supported by the frame at the junction between the down tube 20 and seat tube 23. A motor 51 is supported by the support portion of the chain stay 24, and is thus positioned in a gap between a periphery of the rear wheel 14 and the seat tube 23, between the chain stay 24 and the seat stay 25.

A drive shaft of the motor 51 may be generally parallel to the axle 40 and supports a pulley (not shown), or chain ring/sprocket. The drive shaft projects toward the left-handle side of the frame 12, while the pedal drive train is on the right-hand side of the frame 12.

The pulley is accommodated in a triangular shape cover from which protrudes rearwardly a belt 52 (or a chain, in accordance with the accessory used on the drive shaft). The belt 52 is peripherally mounted to an oversized pulley 53 mounted to the axle 40. Although shown as oversized, the pulley 53 may be of any appropriate diameter. Accordingly, the bicycle 10 of FIGS. 1 and 2 features a pulley and belt drive, although chain and sprocket configurations could be used as well. The pulley 53 mounted to the axle 40 may be in a fixed relation with the axle 40 and thus with the wheel 14. However, a free wheel may be used as well to allow coasting in the absence of drive from the motor 51. In an embodiment, the free wheel of the cassette 33 is used. The pulley and belt drive can be a multi-v drive, or any appropriate drive (e.g., synchronous belt, vee belt).

As the pulley 53 is positioned on the other side of the wheel 14 when compared to the cassette 33, the electrical drive system illustrated in FIGS. 1 and 2 allows the combined drive from the rider of the bicycle and the electrical drive system. However, it is also considered to have the pulley 53 and cassette 33 on the same side as well. The pulley 53 may be connected to the wheel 14 by a free wheel, or without a free wheel. The presence of a free wheel advantageously removes the impact of the motor inertia when the motor is not assisting the pedaling. The pulley 53 may also be fixed in rotation to the wheel 14, in the instance where the motor is used as an alternator to recharge the battery. It is pointed out that the free wheel of the electrical drive system may be located in the electrical drive system so as to use coasting to recharge the battery pack 50 via the use of the motor 51 as an alternator.

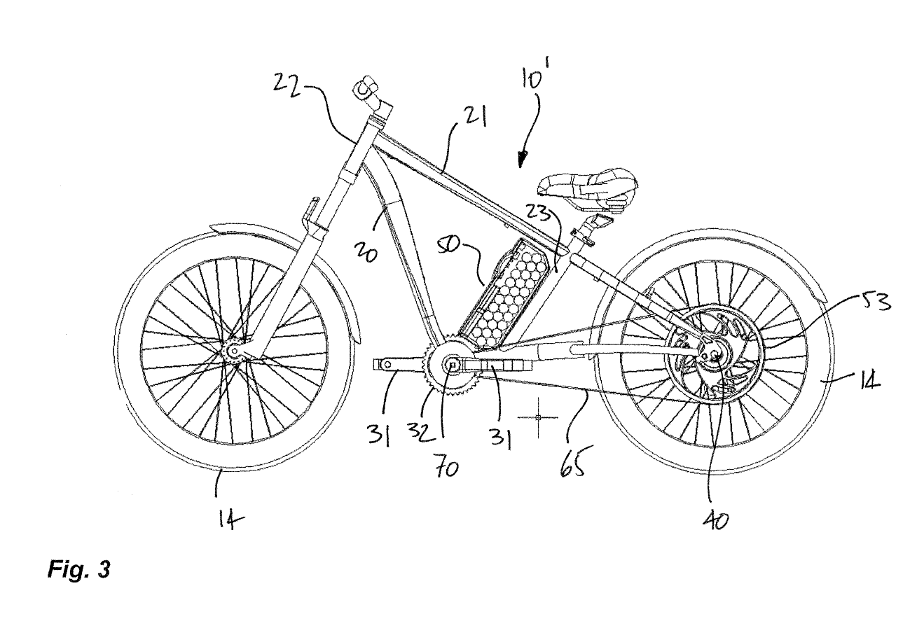

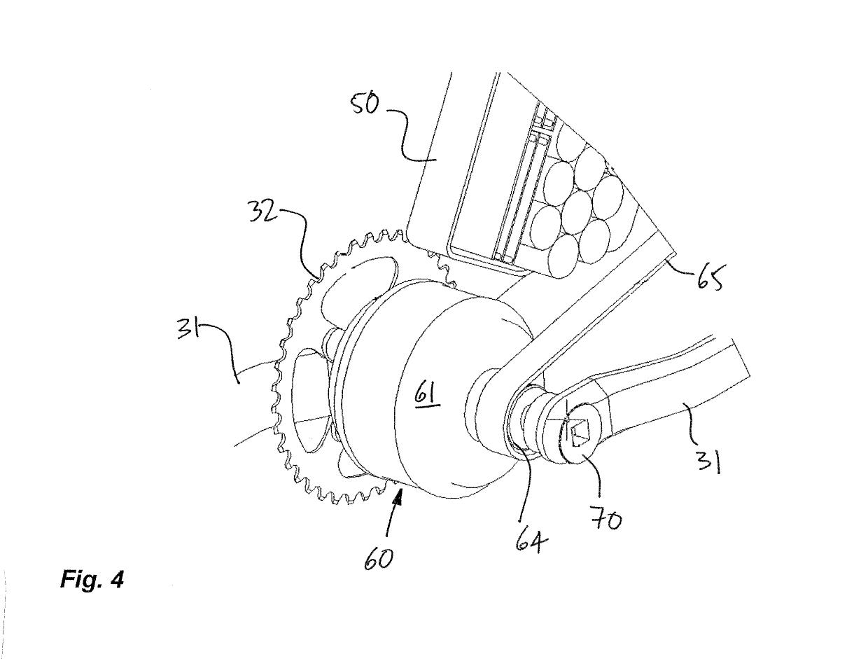

Referring concurrently to FIGS. 3 to 6, a bicycle in accordance with another embodiment of the present disclosure is illustrated at 10′. The bicycle 10′ of FIGS. 3 to 6 has numerous components similar to that of bicycle 10 of FIGS. 1 and 2, whereby like elements will bear like reference numerals.

The significant difference between the bicycles 10 and 10′ is the positioning of the motor of the electrical drive system. The motor is located in an oversized bottom bracket shell 60. The oversized bottom bracket shell 60 forms a casing 61 in which the motor 62 and bottom bracket are concealed. The motor 62 may be any type of electric motor, such as a brushless DC motor, with a stator 62A being fixedly received in the bottom bracket shell 60, while a rotor 62B (e.g., permanent magnet rotor) is inside the stator 62A. Accordingly, the motor 62 is actuated by the power source to cause a rotation of the rotor 62B.

A drive shaft of the motor 62 is the axle tube 63, and is therefore hollow. The axle tube 63 is integral with the rotor 62B, and is supported to the bottom bracket shell 60 by bearings 63A. A longitudinal axis of the axle tube 63 is parallel to the rotational axis of the axle 40 of the bicycle 10′. A transmission is used to transmit the drive from the motor 62 to the rear wheel 14. The transmission may feature a pulley 64 integral with the axle tube 63 on the left-hand side of the bicycle 10′ and therefore on the side opposite to the chain ring 32 and pedal drive train. However, the pulley 64 could also be on the right hand side of the bicycle 10′.

By the configuration of the drive of the electrical drive system, rotation of the axle tube 63 is independent from that of the drive train of the bicycle. A drive transmitting unit such as belt 65 interrelates the pulley to the oversized pulley 53. However, alternative solutions to the pulley and belt drive can be used such as a chain and sprockets, etc.

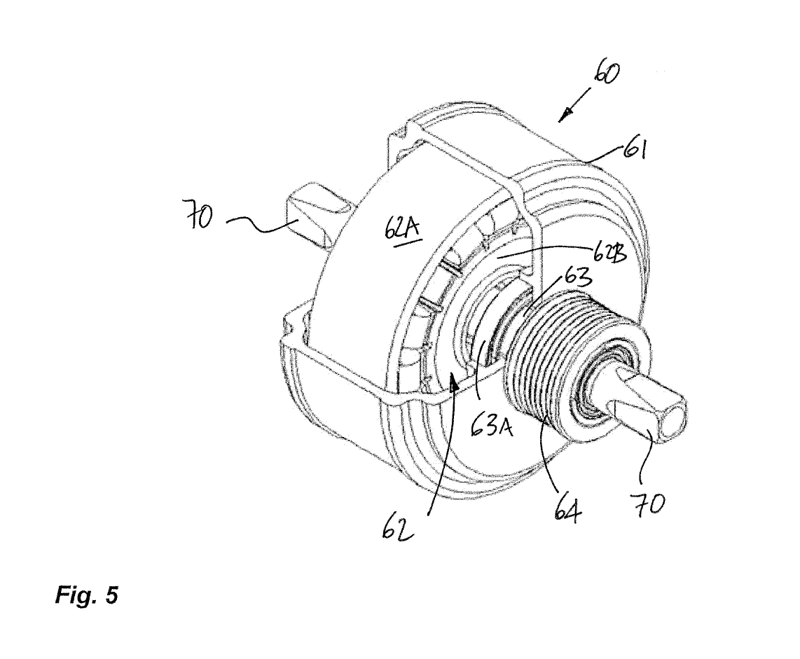

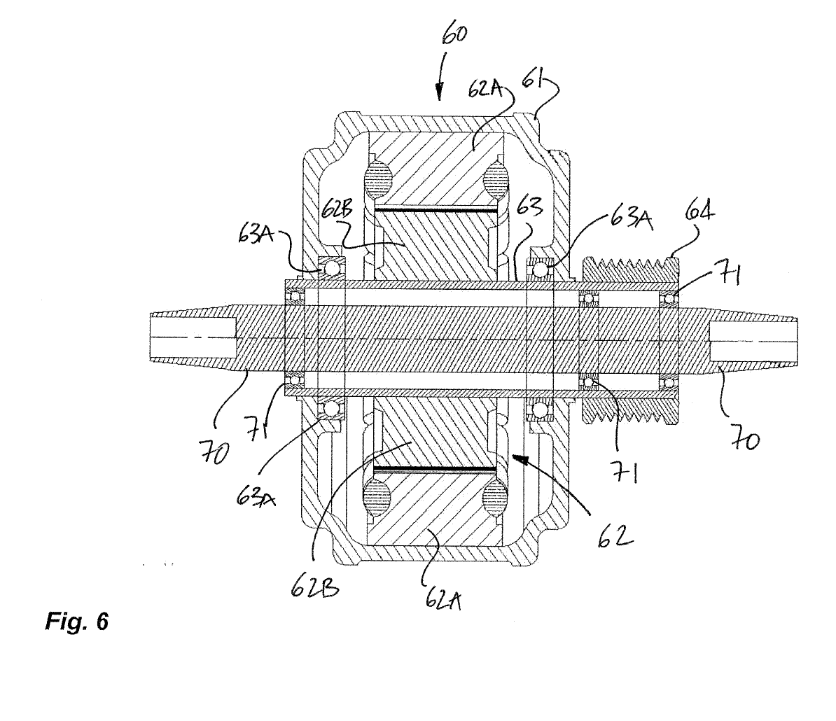

Referring to FIGS. 5 and 6, an axle of the bottom bracket supporting the crank set 30 is illustrated at 70. In the illustrated embodiment, the axle 70 is supported in the axle tube 63 by way of bearings 71, with ends of the axle 70 projecting from opposed ends of the axle tube 63. The axle 70 could also be separate from the axle tube 63. It is observed that two of the bearings may be provided on the side of the pulley 64, to strengthen the axle tube 63 thereat. Therefore, the bearings 71 allow a rotation of the axle 70 and of the crank set 30 independent from that of axle tube 63. In the illustrated embodiment, the axes of rotation of the axle tube 63 and axle 70 of the crank set are coincident, as this configuration is space-efficient, but other eccentric configurations are possible. Other types of bottom brackets may be used as well.

The operation of the electrical drive system of the bicycle 10′ FIGS. 3 to 6 is similar to that of the electrical drive system of bicycle 10 of FIGS. 1 and 2.

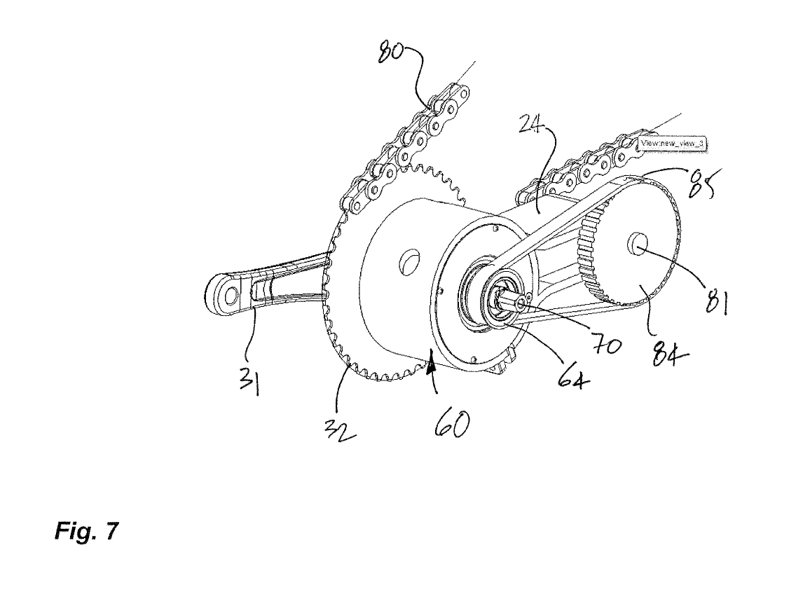

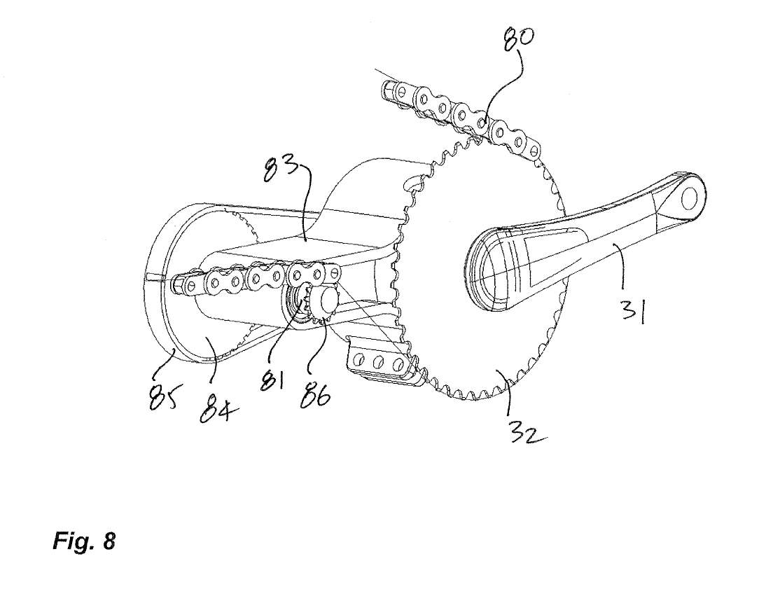

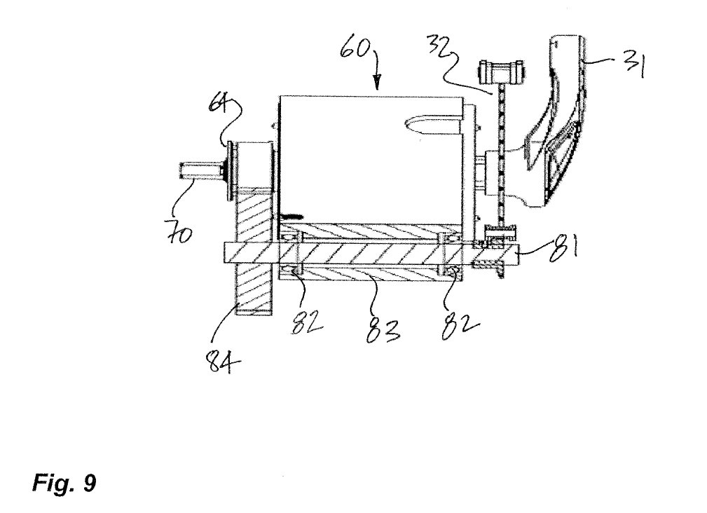

Referring to FIGS. 7-9, there is illustrated an alternative drive configuration for the motor 62 of FIGS. 3-6. However, as several components are used commonly in the embodiments of FIGS. 3-6 and 7-9, like components will bear like reference numerals.

The significant difference between the embodiments of FIGS. 3-6 and of FIGS. 7-9 is that the motor 62 does not drive the rear wheel directly in FIGS. 7-9, but rather uses the standard bicycle drive, namely chain 80 between the chain ring 32 and cassette 33 (FIG. 2), by way of a transmission. According to an embodiment, the transmission has a transfer axle 81 that is rotatably mounted to the frame of the bicycle, for instance by way of bearings 82 in a support bracket 83 that is part of or adjacent to the chain stays 24. The support bracket 83 may also be connected to the seat tube 23 (FIG. 2), to the seat stays 25. A pulley 84 (or sprocket, gear, etc) is secured to the transfer axle 81, on the left side of the frame, with a belt 85 between the pulley 64 and the pulley 84 for the transmission of the drive from the motor 62 to the axle 81.

A sprocket 86 is secured to the other end of the axle 81. The sprocket 86 is therefore meshed with the chain 80, so as to transmit the drive of the motor 62 to the rear wheel 14 concurrently with the pedaling power. In an embodiment, the crank set 30 has some form of freewheel mechanism (i.e., ratchet), so as to allow the rider to coast while the motor 62 drives the rear wheel, and thus allow the temporary release of the cranks 31 from the chain ring 32. Such type of crank set is referred to as a freewheeling crank set.

The sprocket 86 may alternatively be a gear meshed with the chain ring 32, etc. Also, there may be provided some play in the axial position of the sprocket 86 along the axle 81, to allow shifting of the chain 80 between chain rings 32 in a multi-chain ring crank set.

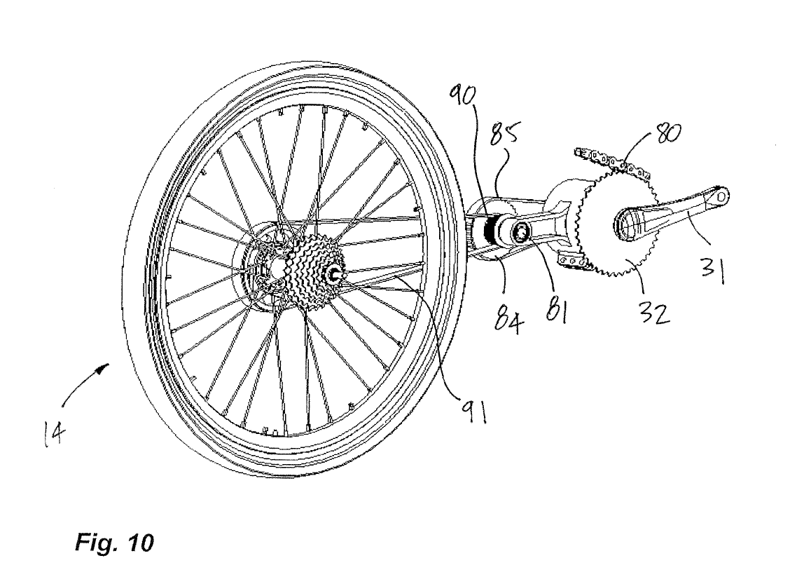

Referring to FIG. 10, the transfer axle 81 is illustrated as having an output wheel 90 (shown as a pulley, but alternatively a gear, sprocket, etc) related to the rear wheel 14 by way of a drive transmitting unit (shown as a belt, but alternatively gears, a chain, etc). The output wheel 90 is on the same side of the frame as the pulley 84, but has a different diameter, thereby resulting in a mechanical advantage appropriate for the type of motor used relatively to the anticipated velocity range of the bicycle. Any appropriate gear ratios may be used with the transfer axle 81. Moreover, the mechanical advantage may also be obtained y having the drive transmitting unit 91 on the same side as the drive train of the bicycle.

1. An electrically-driven bicycle comprising:
a bicycle frame having a front frame portion to which a front wheel is rotatably mounted, and a rear frame portion to which a rear wheel is rotatably mounted, with a bottom bracket shell at a junction between a down tube of the front frame portion and stays of the rear frame portion;
an electric motor connected to the bottom bracket shell, the electric motor having a hollow drive shaft with an output end projecting to a first side of the bottom bracket shell;
a transmission connecting the output end of the drive shaft to one of the rear wheel and a drive train of the bicycle, to transmit a drive of the electric motor to the rear wheel; and
the drive train comprising a crank set having an axle rotatably mounted within the hollow drive shaft for rotating independently from the drive shaft, and means for transmitting pedaling actuation on the crank set to the rear wheel, the means being on the second side of the bottom bracket shell.

2. The electrically-driven bicycle according to claim 1, wherein coils of the electric motor are accommodated in the bottom bracket shell.

3. The electrically-driven bicycle according to claim 1, wherein the hollow drive shaft is rotatably mounted to the bottom bracket shell by bearings.

4. The electrically-driven bicycle according to claim 1, wherein the transmission comprises a drive transmitting unit between the output end of the hollow drive shaft and a hub of the rear wheel, to directly transmit the drive of the electric motor to the rear wheel.

5. The electrically-driven bicycle according to claim 1, wherein the transmission comprises a drive transmitting unit between the output end of the hollow drive shaft and a transfer axle rotatably mounted to the stays, to transmit a drive of the electric motor to the rear wheel through the transfer axle.

6. The electrically-driven bicycle according to claim 5, wherein the transfer axle has a sprocket operatively engaged with a chain of the drive train.

7. The electrically-driven bicycle according to claim 6, wherein the crank set has a ratchet system between cranks and a chain ring of the drive train.

8. The electrically-driven bicycle according to claim 5, wherein the transfer axle is operatively connected to the rear wheel by a second drive transmitting unit, the transfer axle having at least one of gears, pulleys and sprockets at an input end and output end for altering a transmission ratio between the drive transmitting units.

9. The electrically-driven bicycle according to claim 1, wherein the transmission comprises one of pulleys and at least one belt, and of sprockets and at least one chain.

10. The electrically-driven bicycle according to claim 1, wherein the axle of the crank set is rotatably mounted inside the hollow drive shaft of the electric motor by bearings.

11. The electrically-driven bicycle according to claim 1, wherein rotational axes of the hollow drive shaft and of the axle are coincident.

12. An electrical drive system for bicycle comprising:
a stator adapted to be fixedly received in a bottom bracket shell of a bicycle frame;
a hollow drive shaft supporting a rotor and adapted to rotate as actuated by the cooperation of the rotor and the stator, the hollow drive shaft sized to have an output end projecting to a side of the bottom bracket shell away from a drive train of the bicycle;
axle bearings in an inner cavity of the hollow drive shaft adapted to rollingly support an axle of a crank set such that the axle projects from both ends of the drive shaft; and
a transmission adapted to connect the output end of the drive shaft to one of the rear wheel and a drive train of the bicycle, to transmit a drive of the electrical drive system to the bicycle.

13. The electrical drive system according to claim 12, further comprising bottom bracket bearings, and wherein the hollow drive shaft is adapted to be rotatably supporting to the bottom bracket shell by the bottom bracket bearings.

14. The electrical drive system according to claim 12, wherein the transmission comprises a drive transmitting unit between the output end of the hollow drive shaft and a hub of the rear wheel, to directly transmit the drive of the electrical drive system to the rear wheel.

15. The electrical drive system according to claim 12, wherein the transmission comprises a drive transmitting unit between the output end of the hollow drive shaft and a transfer axle adapted to be rotatably mounted to the stays, to transmit a drive of the electric motor to the rear wheel through the transfer axle.

16. The electrical drive system according to claim 15, wherein the transfer axle has a sprocket adapted to be operatively engaged with a chain of the drive train.

17. The electrical drive system according to claim 15, wherein the transfer axle is operatively connected to the rear wheel by a second drive transmitting unit, the transfer axle having at least one of gears, pulleys and sprockets at an input end and output end for altering a transmission ratio between the drive transmitting units.

18. The electrical drive system according to claim 12, wherein the transmission comprises one of pulleys and at least one belt, and of sprockets and at least one chain.

19. The electrical drive system according to claim 12, wherein rotational axes of the hollow drive shaft and of the axle bearings are coincident.
